(19) United States
(12) Patent Application Publication
(10) Pub. No.: US 2008/0086381 A1
(43) Pub. Date: Apr. 10, 2008

(54) Point-Of-Sale Food Servings Calculator

(76) Inventor: Barry Fisher, Manhattan Beach, CA (US)

Correspondence Address: MINTZ, LEVIN, COHN, FERRIS, GLOVSKY AND POPEO, P.C, 5355 Mira Sorrento Place, Suite 600, SAN DIEGO, CA, 92121, US

(21) Appl. No.: 11/853,718

(22) Filed: Sep. 11, 2007

Related U.S. Application Data
(60) Provisional application No. 60/843,845, filed on Sep. 11, 2006.

(51) Int. Cl. G06Q 50/00

(52) U.S. Cl. 705/15

(57) ABSTRACT

A food servings calculator is presented. The calculator can be implemented as a computer-implemented method or point-of-sale system. Serving information for one or more foods is stored, preferably in a database. A number of servings of at least one food being purchased is electronically determined based on the serving information. The number of servings is then displayed for a purchaser of the at least one food being purchased, such as on an electronic display or paper print-out.

### CROSS-REFERENCE TO RELATED APPLICATION

This application claims the benefit under 35 U.S.C. Section 119(e) of the following: U.S. Provisional Patent Application No. 60/843,845, entitled “POINT-OF-SALE FOOD SERVINGS CALCULATOR,” filed Sep. 11, 2006, which is incorporated by reference herein.

### BACKGROUND

A healthy diet is widely believed to include a substantial amount of fruits and vegetables. For instance, the United States Department of Agriculture (USDA), whose mission is to advance and promote dietary guidance for all Americans, sets dietary standards for the United States and releases its recommendations every five years for recommended intake of certain foods for a balanced diet.

Currently, the USDA recommends five to nine “servings” of fruits and vegetables per day. However, few consumers know what the USDA program is, and fewer still who understand what a “serving” is. While most consumers know they should eat more fruits and vegetables, given the typical western diet and modern purchasing habits, very few know how much fruits and vegetables they should eat.

### SUMMARY

This document discloses a food servings calculator, suitable for use in a point of sale system. In one aspect, a computer-implemented method includes steps or sub-processes of storing serving information for one or more foods, electronically determining a number of servings of at least one food being purchased based on the serving information, and displaying the number of servings for a purchaser of the at least one food being purchased.

In another aspect, a computer-implemented method includes the sub-processes of electronically determining a number of servings of at least one food being purchased based on serving information stored in a point of sale (POS) system, and displaying, with the POS system, the number of servings for a purchaser of the at least one food being purchased.

In yet another aspect, a point of sale (POS) system for foods includes a database storing serving information for one or more foods, and a terminal that determines a number of units of a food being purchased. The POS system further includes a computer that calculates a number of servings of the food being purchased based on a comparison of the serving information and the number of units of the food being purchased.

The details of one or more variations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a display that informs a purchaser of foods of serving information.

FIG. 2 is a block diagram of a system for processing and displaying serving information.

FIG. 3 is a flowchart of a method for calculating and displaying serving information.

Like reference symbols in the various drawings indicate like elements.

### DETAILED DESCRIPTION

This document describes a system and method for determining a number of daily servings of a food product, and displaying that number to a consumer at a point of sale (POS) system. In particular exemplary embodiments, the number of daily servings relates to an amount of a food product, such as a fruit or vegetable, that a consumer is purchasing at the POS system, and the number is calculated based on the purchase and then displayed along with an itemized list of checkout items, such as on a graphics display or printed receipt. These and other variations will be explained further as follows.

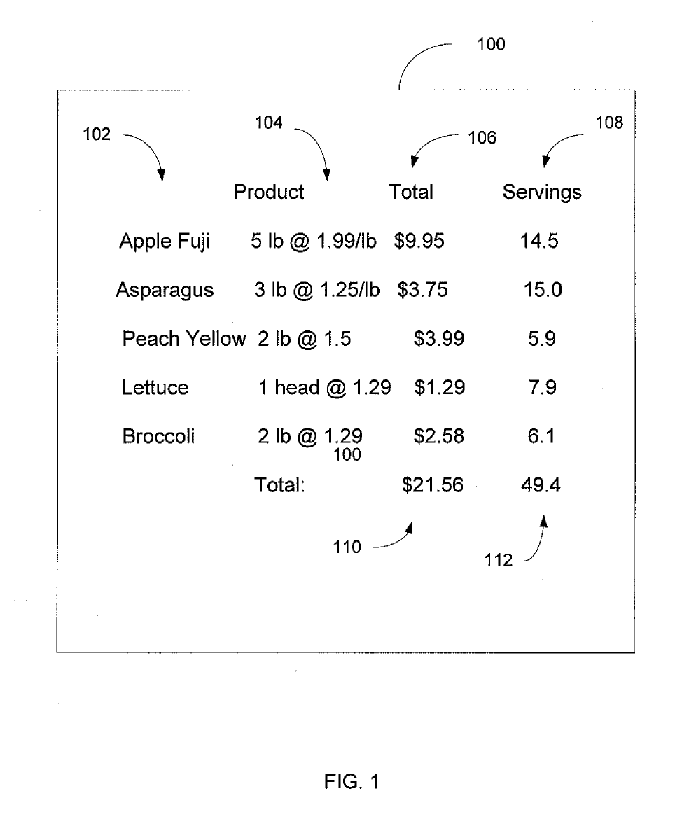

FIG. 1 shows an exemplary display 100 that informs a purchaser of a purchase of a number of foods 102. In the example shown, the foods 102 include fruits such as “Apple Fuji” and “Peach Yellow,” indicative of specific types of fruits, and vegetables “Asparagus,” “Lettuce” and “Broccoli.” It should be understood that these fruits and vegetables are merely examples only, and that the invention applies to any types of foods, but particularly to those foods that are the subject of a recommended “serving” consumption. The display 100 can be a hardcopy display, such as on a printed receipt or page, or an electronic display, such as on a cathode ray tube (CRT) display, liquid crystal display (LCD), plasma screen, or other type of electronic display.

The display 100 includes an indication of foods 102 being purchased, an indication of a weight 104 of each food being purchased and/or price per unit of weight, a price 106 for the food being purchased (based on the price per unit of weight or simply the weight 104), and an indication of a number of servings 108 that is represented by each food being purchased. The servings 108 are based on any of a number of standards that recommend to consumers an amount of a specific food that should be consumed on a daily or other regular basis. Accordingly, the display of the servings 108 gives a consumer knowledge as to the effectiveness of a food purchase given modern food consumption recommendation standards.

The display 100 further includes a total price 110 of a purchase, based on a cumulative addition of the prices 106 all foods being purchased. The display 100 also includes a total number of servings 112 of a purchase, based on a cumulative addition of the servings 108 of all foods being purchased. Thus, a consumer can realize in an instant how an overall purchase measures against regular consumption guidelines or standards, coincident with checking the monetary result of the purchase. In some variations, the total number of servings 112 can be divided by a number of persons in a group, such as a number of family members, to arrive at a total number of servings per person in the group. In other alternatives, the number of persons in the group can be assigned a value or weight based on a number of factors such as age, weight, sex, blood-type, or other physiological or metabolic factors.

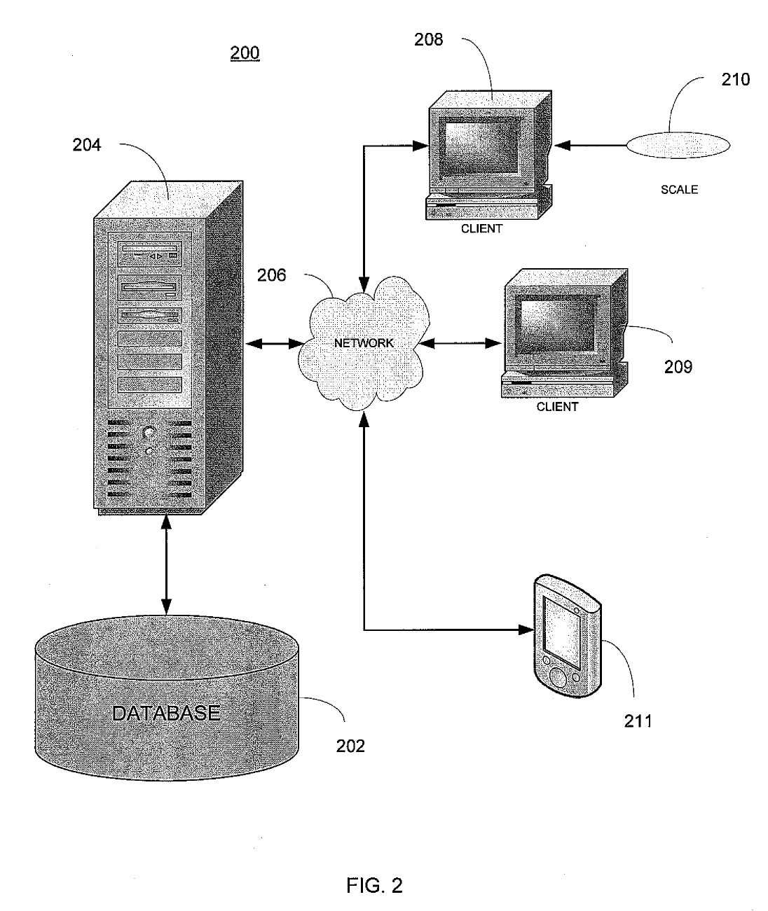

FIG. 2 is a block diagram of a system 200 that is suitable for calculating and displaying a number of servings of food being purchased. The system 200 includes a database 202 that stores servings information for various foods, and a server 204 that can process the servings information in any of a variety of ways using any of a number of server-based software tools or applications. The server 204 is connected through a network 206 to one or more clients including, without limitation, a POS system 208, a client computer 209 and/or a wireless device 211. The POS system 208 can include a register and a scale 210, and may also be equipped with a scanner or other input device such as a barcode reader, keypad, RFID sensor, etc. The client computer 209 can be a personal computer (PC), laptop computer, or tablet PC. The wireless device 211 can be a cellular telephone, personal digital assistant (PDA), or other wireless computing device.

In some variations, the database 202 stores a table of the latest guidelines of servings information relating to a number of foods, such as fruits and vegetables. Information about a purchase obtained at any of the clients is transmitted to the server 204 where it is processed against the table in the database 202, so that the server 204 calculates a number of servings for the purchase and transmits that information back to the client. In other variations, the servings information is stored locally with the clients, and the calculation of servings for a purchase is executed locally in real-time. Still yet in other variations, servings information and calculations are client-based, while a history of such information and calculations is transmitted to and stored in the database 202 and available for future analysis and processing by the server, for access by a client later. As such, objects such as trends, nutritional analysis, consumption behavior, and other information can be gathered and persisted for creating a web-based servings information tool.

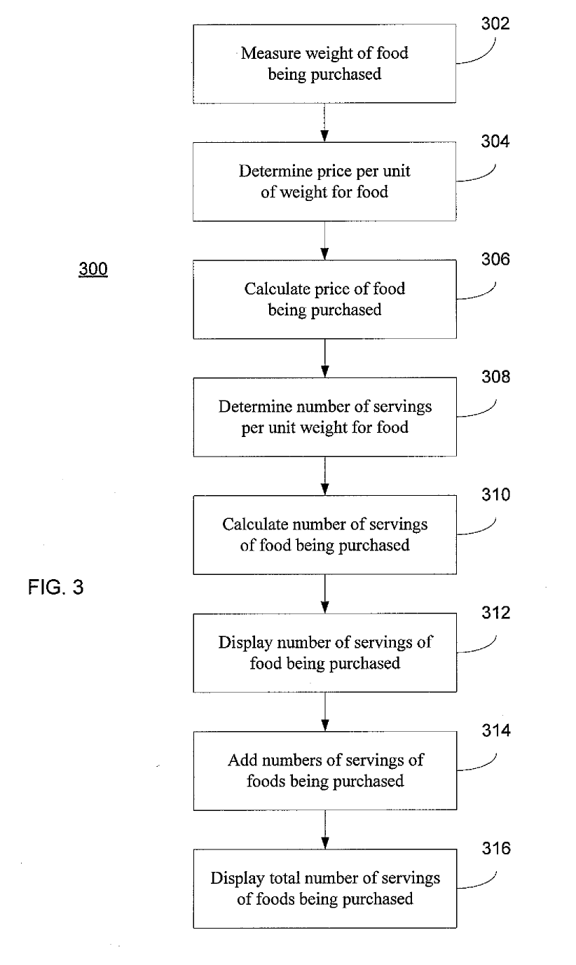

FIG. 3 is a flowchart of a process 300 for displaying a number of servings of food being purchased. At 302, a weight of a food being purchased is measured, and at 304 a price per unit of weight for the food is determined. Alternatively, a price per unit of the food is determined, such as by scanner, entry of a product code, etc. At 306, a price of the food being purchased is calculated. These steps are performed for one or more foods, alone or in combination.

At 308, a number of servings per unit weight of the food is determined. Alternatively, the number of servings is determined per unit of the food. The determination is preferably made by comparison of the weight of the food or unit of the food being purchased with a look-up table or other data structure that contains servings information, such as how much of a particular food makes up a “serving.” Based on the servings per unit weight of the food or servings per unit of the food that is determined, at 310 a number of servings of the food being purchased is calculated. The number of servings of the food is displayed, either in hardcopy or electronic form, at 312.

At 314, the number of servings of all foods being purchased is added together to calculate a total number of servings. Alternatively, the number of servings is added only for selected foods, such as only fruits or only vegetables, based on consumer or merchant preferences. At 316, the total number of servings is displayed, again either in hardcopy, electronic form, or both. The number of servings or total number of servings, or both, can be stored electronically for later access and use. The total number of servings can be divided by a number of a persons in a party, such as a family, for instance. Each person can be assigned a unique weight or value based upon one or more of a number of factors, such as weight, age, body mass index (BMI), metabolic factors, or the like.

Variations of the invention and all of the functional operations described in this specification can be implemented in digital electronic circuitry, or in computer software, firmware, or hardware, including the structures disclosed in this specification and their structural equivalents, or in combinations of them. Variations of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, variations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Variations of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results.

What is claimed:

1. A computer-implemented method comprising:
storing serving information for one or more foods;
electronically determining a number of servings of at least one food being purchased based on the serving information; and
displaying the number of servings for a purchaser of the at least one food being purchased.

2. A computer-implemented method in accordance with claim 1, further comprising measuring a weight of the at least one food being purchased.

3. A computer-implemented method in accordance with claim 2, wherein electronically determining the number of servings of the at least one food being purchased is further based on the weight of the at least one food being purchased.

4. A computer-implemented method in accordance with claim 1, further comprising determining a number of units of the at least one food being purchased.

5. A computer-implemented method in accordance with claim 4, wherein electronically determining the number of servings of the at least one food being purchased is further based on the number of units of the at least one food being purchased.

6. A computer-implemented method in accordance with claim 1, further comprising:
adding the number of servings of two or more foods being purchased to generate a total number of servings; and
displaying the total number of servings for a purchaser of the two or more foods being purchased.

7. A computer-implemented method in accordance with claim 1, further comprising storing the number of servings in a database.

8. A computer-implemented method comprising:
electronically determining a number of servings of at least one food being purchased based on serving information stored in a point of sale (POS) system; and
displaying, with the POS system, the number of servings for a purchaser of the at least one food being purchased.

9. A computer-implemented method in accordance with claim 8, further comprising storing the serving information in the POS system.

10. A computer-implemented method in accordance with claim 8, further comprising measuring a weight of the at least one food being purchased.

11. A computer-implemented method in accordance with claim 10, wherein electronically determining the number of servings of the at least one food being purchased is further based on the weight of the at least one food being purchased.

12. A computer-implemented method in accordance with claim 8, further comprising determining a number of units of the at least one food being purchased.

13. A computer-implemented method in accordance with claim 12, wherein electronically determining the number of servings of the at least one food being purchased is further based on the number of units of the at least one food being purchased.

14. A computer-implemented method in accordance with claim 8, further comprising:
adding the number of servings of two or more foods being purchased to generate a total number of servings; and
displaying the total number of servings for a purchaser of the two or more foods being purchased.

15. A computer-implemented method in accordance with claim 8, further comprising storing the number of servings in a database.

16. A point of sale (POS) system for foods, comprising:
a database storing serving information for one or more foods;
a terminal that determines a number of units of a food being purchased; and
a computer that calculates a number of servings of the food being purchased based on a comparison of the serving information and the number of units of the food being purchased.

17. A POS system in accordance with claim 16, further comprising a display system to display the number of servings of the food being purchased.

18. A POS system in accordance with claim 17, wherein the display system is a graphical display.

19. A POS system in accordance with claim 17, wherein the display system includes a printer and paper.

20. A POS system in accordance with claim 16, further comprising a scale that measures a weight of the food being purchased.
